(19) United States
(12) Patent Application Publication
(10) Pub. No.: US 2009/0094111 A1
(43) Pub. Date: Apr. 9, 2009

(54) Advertising framework for wireless networks

(75) Inventors: Deyun Wu, Sammamish, WA (US); Thomas W. Kuehnel, Seattle, WA (US); Amer A. Hassan, Kirkland, WA (US); Andrew T. Baron, Redmond, WA (US); Yi Lu, Sammamish, WA (US); Hui Shen, Sammamish, WA (US); David Jones, Seattle, WA (US); John W. Archer, Marysville, WA (US); Sundar P. Subramani, Bellevue, WA (US); Vinod Kl Swamy, Bellevue, WA (US)

Correspondence Address: WOLF GREENFIELD (Microsoft Corporation);C/O WOLF, GREENFIELD & SACKS, P.C., 600 ATLANTIC AVENUE, BOSTON, MA, 02210-2206, US

(73) Assignee: Microsoft Corporation, Redmond, WA (US)

(21) Appl. No.: 11/973,589

(22) Filed: Oct. 9, 2007

(51) Int. Cl. G06Q 30/00

(52) U.S. Cl. 705/14

(57) ABSTRACT

An advertising framework for transmitting advertisements from wireless access points to client devices that need not be connected to the wireless access point. The client device can display the advertisements on a user interface of the client device. Such advertisements may be transmitted, for example, as part of a control message transmitted by a wireless access point of a wireless network, or other message conventionally used to broadcast network characteristics necessary for a client device to establish a connection to the wireless access point. In terms of the Open Systems Interconnect (OSI) layered model of a network, layer 2 control messages, including announcement transmissions such as beacons, may be used for control messages.

### BACKGROUND OF INVENTION

Conventional web-based advertising frameworks typically transmit advertisements to consumers of a web-based service through a connection the client device has established, through a network, to a server hosting the web-based service. For example, the owner/administrator of a server may configure the server to transmit to the client device a web page with an advertisement in response to a user of a client device entering a Uniform Resource Locator (URL) into the client device. The advertisement may be in the form of text/image/video/audio data and may be embedded in the web page, or may be an initial web page to be displayed to the user prior to displaying the web page accessed by the client device.

In such advertising frameworks, advertisements are exchanged between a web-based service (e.g., a web site) and users of the web-based service. The network to which a user's client device connects and through which the client device accesses the web-based service has limited involvement in controlling the content of the web page and thus has limited capability to provide advertisements to a user of the client device. Instead, some networks implement alternative, complementary advertising frameworks, for example, ones which transmit web pages containing advertisements to users of client devices connected to the network. The advertising frameworks implemented by these networks, for example, may require a user of the network to view an initial web page when first connecting to the network, or may periodically transmit web pages containing advertisements to client devices using the network.

### SUMMARY OF INVENTION

Conventional advertising frameworks for wireless networks are limited in their ability to transmit advertisements to users, as the advertisements may only be transmitted to client devices with an established connection to the wireless network and/or which are requesting data from the wireless network. If advertisements could be transmitted to client devices not connected to a wireless network, then the advertisements may reach more users and advertising businesses may draw more customers and more revenue. Embodiments of the invention are directed to advertising frameworks to be implemented in a wireless network which transmits advertisements to client devices not connected to the wireless network. In this way, advertisements may reach more potential customers than in conventional advertising frameworks in which only users of client devices already using a service or already connected to a network could receive advertisements. Further, advertisements may be more targeted to likely potential customers, as advertisements transmitted from one or more wireless access points in close proximity to a business will reach client devices within range of the wireless access point and therefore near the business.

The client device may be configured to extract the information describing the advertisement from announcement transmissions. The client device may have a user interface through which advertisements may be presented to alert a user that advertised data is available.

The advertisements may be encoded in control messages or announcement transmissions that are made by the wireless access point, even to client device not connected to a network with the wireless access point. Layer 2 control messages, such as a beacon, probe response, or other suitable transmission may be used for this purpose. An advertisement may be encoded as one or more information elements in a field defined as optional according to a standard protocol for such a message.

In some embodiments of the invention, an entity having a wireless network may specify at least one commercial service associated with the entity, encode in a wireless access point an advertisement for the at least one commercial service, and transmit, from the wireless access point, at least one control message or announcement transmission comprising the advertisement.

In one embodiment, a method is performed in a wireless access point associated with a commercial entity in proximity to the wireless access point offering at least one commercial service. The method comprises encoding in the wireless access point an advertisement for the at least one commercial service, and transmitting, from the wireless access point, at least one announcement transmission comprising the advertisement for the at least one commercial service.

In another embodiment, there is provided a client device operating in a network environment comprising a plurality of wireless access points. In the network environment, at least a portion of the wireless access points are within range of the client device. The client device comprises a wireless network interface adapted to receive at least one announcement transmission from each wireless access point in the portion. The client device further comprises a processor adapted to receive from the wireless network interface advertisement data from each announcement transmission of the at least one announcement transmission from each wireless access point in the portion. The advertising data received from the wireless network interface describes a commercial service offered by a commercial entity associated with a wireless access point in the portion. The client device further comprises a user interface adapted to present the advertisement data to a user of the client device.

In a further embodiment, there is provided a method of operating a client device in a network environment comprising a plurality of wireless access points. In the network environment, at least a portion of the wireless access points are within range of the client device. The method comprises receiving at least one control message from each wireless access point in the portion, and reading advertisement data from each control message of the at least one control message from each wireless access point in the portion. The advertising data describes at least one commercial service offered by a commercial entity associated with a wireless access point in the portion. The method further comprises presenting, via a user interface, advertisements described by the advertisement data.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a diagram of an exemplary computer system in which embodiments of the invention may act;

FIG. 2 is a flowchart of an illustrative process that may be implemented by embodiments of the invention for exchanging information about a commercial service between a wireless network and a client device;

FIG. 3 is a flowchart of an illustrative process that may be implemented by embodiments of the invention for establishing advertisements to be transmitted by a wireless access point;

FIG. 4 is a flowchart of an illustrative process that may be implemented by embodiments of the invention for receiving advertisements at a client device and displaying advertisements to a user;

FIG. 5 is a diagram of exemplary schemes for segmenting advertisement data for transmission to client devices, in accordance with one embodiment of the invention;

FIG. 6 is a diagram of an exemplary format for encoding advertisement data for transmission, in accordance with one embodiment of the invention;

FIGS. 7A, 7B, and 7C are diagrams of exemplary user interfaces that may be implemented by embodiments of the invention;

FIG. 8 is a diagram of an exemplary wireless access point with which embodiments of the invention may act; and

FIG. 9 is a diagram of an exemplary client device with which embodiments of the invention may act.

### DETAILED DESCRIPTION

Applicants have appreciated that both businesses and consumers may benefit from a simple mechanism for making available advertisements to consumers in close proximity, for example, to the locations at which advertised services are available. For example, users may learn of sales or special promotions offered by a businesses. Also, the user can learn about services offered by a business to determine that the user is interested in the services offered by the businesses before entering the premises for that business.

Conversely, advertisers may focus advertisements on potential customers who are near their establishments and therefore most likely to make purchases.

For example, a restaurant having a wireless network may seek to draw more customers by transmitting to client devices within range a description of the restaurant's daily specials. Conventional advertising frameworks, however, while capable of transmitting advertisements to large numbers of users, are limited to displaying advertisements to users of client device already connected to wireless network through the wireless access point and requesting data from the wireless network, and are not capable of displaying advertisements to users not connected to the wireless network or alerting users who do not know to request information that advertisements are available for businesses in close proximity to the user.

Applicants have appreciated the desirability of advertising services of a business, including services such as selling one or more products, to users of client devices not connected to a wireless network operated by the business. If businesses were capable of advertising their products or services to all client devices within range of their wireless networks, rather than just client devices connected to the wireless networks, then the advertisements would be able to reach a wider audience and the business might attract more customers and more revenue. Further, users of client devices within range of the wireless network are the most likely group of potential customers because of their proximity to the business when they receive the transmitted advertisements.

In view of the foregoing, one embodiment of the present invention is directed to an advertising framework for transmitting advertisements from wireless access points to client devices, which may not be connected to the wireless access point, for display on the user interface of the client device. Such advertisements may be transmitted, for example, as part of a control message or announcement transmission transmitted by a wireless access point of a wireless network, which conventional client devices are typically configured to monitor. A message conventionally used to broadcast network characteristics necessary for a client device to establish a connection to the wireless access point may serve as a control message or announcement transmission. For example, in terms of the Open Systems Interconnect (OSI) layered model of a network, layer 2 control messages may be used for control messages. In some embodiments of the invention, a beacon, probe response, or other suitable transmission may be a control message or announcement transmission and may comprise advertisement data that may be displayed to a user of a client device.

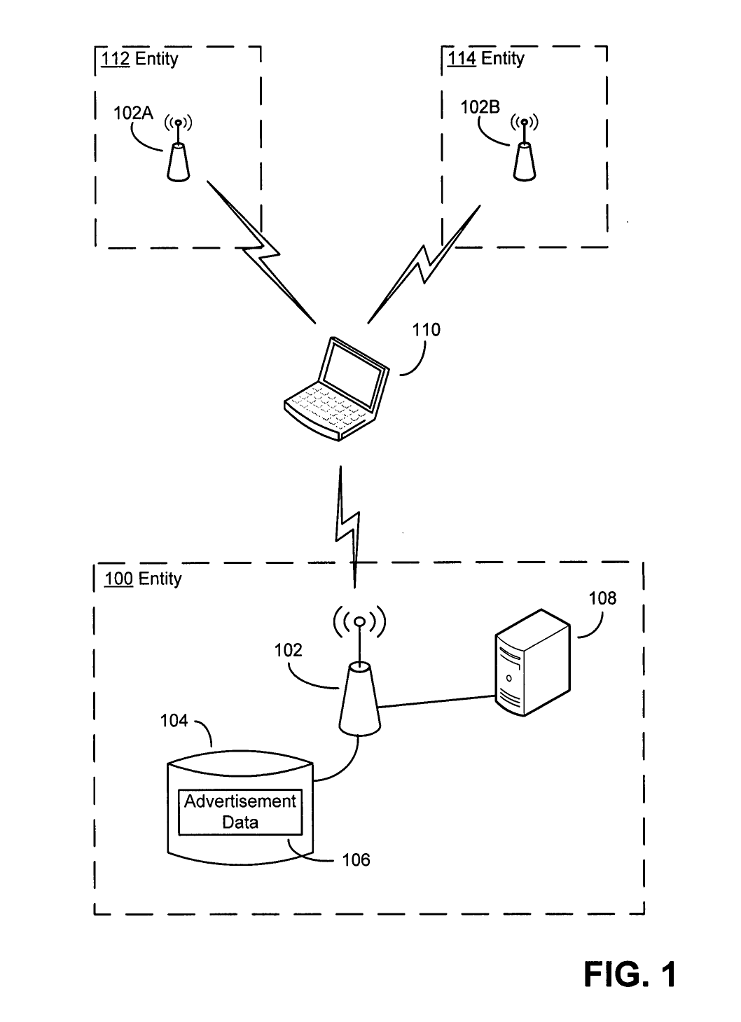

FIG. 1 shows an exemplary computer system in which some embodiments of the invention may act. It should be appreciated that embodiments of the invention may act in any suitable computer system and are not limited to being implemented in the illustrative computer system shown in FIG. 1.

FIG. 1 shows an exemplary client device 110 within range of three wireless access points 102, 102A, and 102B. Each of the wireless access points shown in FIG. 1 is associated with an entity, such as entity 100, entity 112, and entity 114. In some embodiments of the invention, an entity may be a commercial entity such as a business, collection or association of businesses, non-profit/public organization, or other commercial entity, though it should be appreciated that embodiments of the invention are not limited to be implemented with commercial entities. It should be additionally appreciated that, as used herein, an “entity,” including a commercial entity, may be any single entity, such as a person, group, organization, or business, or any combination of persons, groups, organizations, businesses, or any other entities which may be associated with one another in any suitable manner.

FIG. 1 shows in entity 100 an exemplary implementation of an entity (including entities such as entities 112 and 114) in accordance with embodiments of the invention. An entity may comprise at least one wireless access point 102, which may be communicatively coupled to a data store 104 and a server 108 associated with the wireless access point 102. Data store 104 may be any suitable computer-readable medium, and may be a component of the wireless access point 102, or may be coupled to the wireless access point 102 directly or through any suitable wired and/or wireless communication medium or media. As shown in FIG. 1, data store 104 may store information comprising advertisement data that may be retrieved and transmitted by the wireless access point 102. The advertisement data 106 may be any suitable type or types of data that may be transmitted by a wireless access point 102, including, for example, data describing text, images, audio, or video, or any combination thereof. The advertisement data 106 may be data describing a single advertisement for one or more services associated with the entity 100, or may be data describing multiple advertisements for one or more services associated with the entity 100. Exemplary structures for the advertisement data 106 are described in greater detail below.

Server 108 may be any suitable computing apparatus for storing information (e.g., data and/or instructions) to be provided to a client device connected to wireless access point 102. While FIG. 1 shows server 108 as separate from wireless access point 102 and data store 104, in some embodiments of the invention, server 108 may be a component of wireless access point 102 and/or may be implemented as an electronic device comprising a computer-readable medium (or computer-readable media) acting as both a server 108 and a data store 104. In the embodiment illustrated, server 108 is connected to a network that a device may access once it associates with wireless access point 102 and gains access to that network.

The information stored by server 108 may comprise information related to the one or more advertisements described by the advertisement data 106 stored by data store 104. The information related to the one or more advertisements may be any suitable information, including, for example, one or more web pages describing one or more product(s) or service(s) being advertised by the advertisement data 106. In the embodiments illustrated, data store 104 may not fully define contents of advertisements described by the advertisement data 106. However, such advertisements, for example, may contain a URL pointing to server 108 such that a user may select to connect through wireless access point 102 or any other suitable network connection to server 108 to obtain information related to an advertised service.

Wireless access point 102 may be any suitable wireless signal generator generating signals according to one or more wireless networking protocols. For example, the wireless access points may be WiFi access points operating according to the Institute of Electrical and Electronics Engineers (IEEE) 802.11 standard for Wireless Local Area Networks (WLANs), may be cellular-style wireless access points operating a Wireless Wide Area Network (WWAN) according to any suitable WWAN protocol (e.g., the Global System for Mobile Communications (GSM)), personal area network (PAN) protocols such as Bluetooth, other protocols such as the Worldwide Interoperability for Microwave Access (WiMAX) protocol and the Ultra-wideband (UWB) protocol, or any other suitable wireless protocol. In an entity having multiple wireless access points, the wireless access points may be operating according to the same wireless protocol or may be operating according to different wireless protocols.

As shown in FIG. 1, a client device receiving transmissions from one or more wireless access points 102, 102A, and 102B, such as client device 110, may be a laptop personal computer. It should be appreciated, however, that embodiments of the invention are not limited to be implemented with a PDA or a laptop personal computer, and may be implemented with any suitable electronic device for receiving wireless signals, mobile or immobile, such as a desktop or laptop personal computer, a personal digital assistant (PDA), or smart phone.

The client device 110 may or may not have a connection open to one or more wireless access points 102, but is within range of each of the wireless access points 102 and is capable of receiving transmissions from the wireless access points 102. As discussed above, in accordance with embodiments of the invention the transmissions received from the wireless access points 102 may comprise any suitable information, including advertisement data 106 stored by the data store 104. In some embodiments of the invention, the transmissions sent by the wireless access points 102 and received by the client device 110 may be layer 2 control transmissions. Layer 2 control transmissions such as announcement transmissions may comprise any suitable information about the wireless access point 102, including one or more network characteristics enabling a client device receiving the control transmission to open a connection to the wireless access point 102. An announcement transmission may be, for example, a beacon in accordance with an IEEE 802.11 wireless protocol periodically broadcast by a wireless access point 102 to all client devices within range of the wireless access point 102 (including client device 110), a probe response transmitted to a client device 110 in response to a request for control information sent by the client device 110, or any other suitable announcement transmission sent by a wireless access point 102.

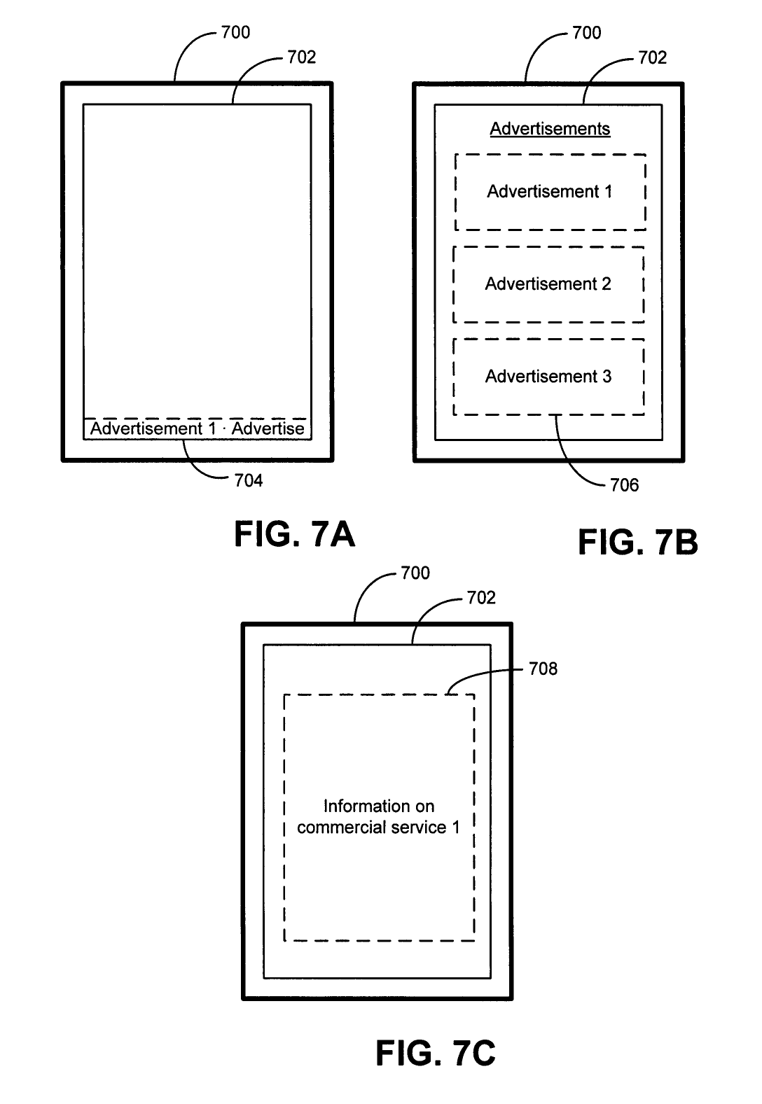

In some embodiments of the invention, a wireless access point 102 may encode in a control transmission the advertisement data 106 stored by the data store 104. As discussed in greater detail below, a client device 110 may be adapted to receive the control transmission comprising the advertisement data 104 and read from the control transmission the advertisement data 104. Once read, the advertisement data 104 may be processed in any suitable manner such that advertisements described by the advertisement data 106 are provided to a user of the client device 110 through any suitable user interface, such as the user interfaces described below in conjunction with FIGS. 7A-7C. A user may then view the advertisements and may indicate to the client device 110 that he or she desires more information on the products or services described by the advertisements. The client device may then, in some embodiments of the invention, establish a connection to a wireless access point transmitting the advertisement in which the user indicated he or she was interested (if the client device 110 does not already have an open connection to the wireless access point), and retrieve any suitable additional information about the one or more services described by the advertisement. In some embodiments of the invention, the additional information may comprise one or more web pages containing more information about the services or one or more web pages from which the user may order or subscribe to the services. It should be appreciated, however, that in embodiments of the invention the additional information may not be one or more web pages and may be any suitable additional information that may be provided to a user of a client device, as embodiments of the invention are not limited in this regard.

It should be appreciated that the exemplary computer system in FIG. 1 is merely illustrative, and that embodiments of the invention may act in any suitable computer system comprising any suitable number of client devices, entities, and wireless access points. Further, it should be appreciated that entities and wireless access points are not limited to being implemented as shown in the example of FIG. 1, as embodiments of the invention may be implemented with any suitable entity employing any suitable hardware and/or software.

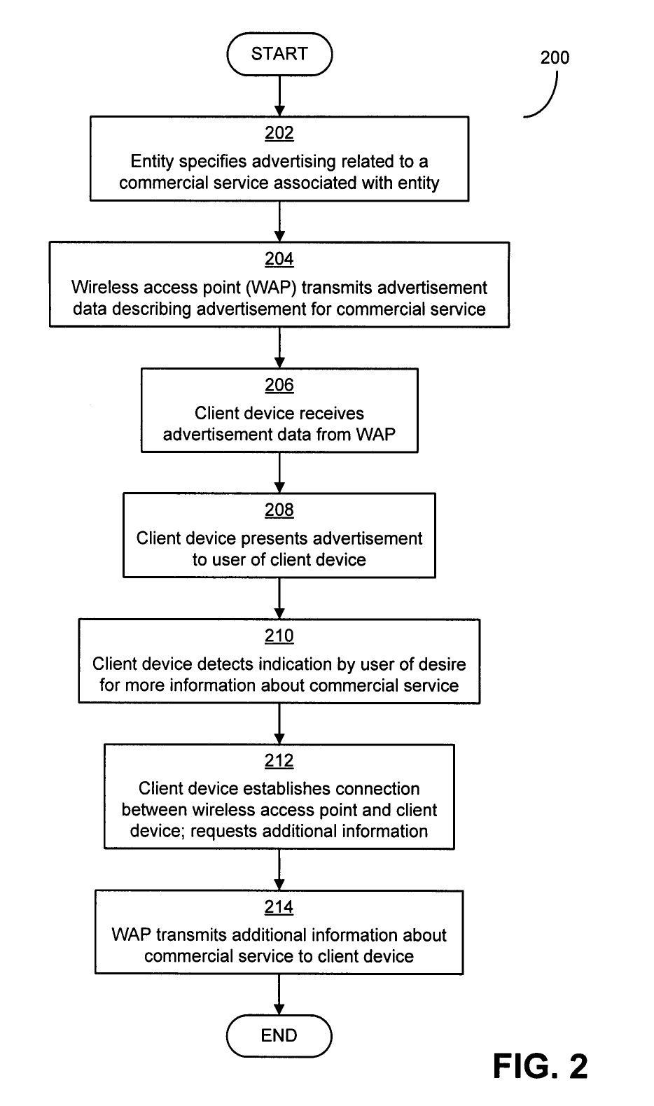

FIG. 2 shows an exemplary process 200 which may be implemented by embodiments of the invention for passing information about products and/or services between a wireless access point 102 of an entity 100 and a client device 110. It should be appreciated that the process 200 is merely illustrative and that embodiments of the invention are not limited to implementing any particular process for exchanging information between a wireless access point and a client device.

The process 200 begins in block 202, wherein an entity (or any person or device associated with an entity) specifies one or more services associated with the entity. The one or more services may be, as shown in FIG. 2, a commercial service, such as sale of a product through any service that may be performed by the entity. For example, if the entity is a restaurant, a commercial service provided by the entity may be serving food and the advertisement relating to the service may describe the specials of the day served by the restaurant. As a further example, if the entity is a restaurant with a relationship (legal or otherwise) with another company (e.g., a moving company), then the specified commercial service provided by the entity may be a service provided by the other company (e.g., the moving services provided by the moving company). As another example, the entity may be a shopping mall and the service provided by the entity may be one or more services provided by other commercial entities such as stores within or associated with the shopping mall. As used herein the term “commercial service” is not limited to services provided by entities for profit. Commercial services may include announcements of events conducted by non-profit or governmental groups, such as free concerts.

In some embodiments of the invention, specifying a commercial service in block 202 may comprise encoding in a data store associated with the wireless access point data describing one or more advertisements for the specified commercial service, while in other embodiments of the invention specifying the commercial service may comprise selecting from a list of preconfigured products and/or services which product(s) and/or service(s) are to be the specified commercial service.

In block 204, the wireless access point transmits advertisement data relating to the specified commercial service. In some embodiments of the invention, the transmission sent by block 204 may be part of a control transmission sent by the wireless access point and may be, in some embodiments of the invention, an announcement transmission such as a beacon broadcast periodically to all client devices within range of the client device.

The client device receives the transmission of block 204 comprising the advertisement data in block 206 and performs any suitable processing on the transmission. In some embodiments of the invention, the processing of block 206 may comprise reading from the advertisement data from the received transmission as well as any other suitable processing steps. In block 208, the advertisement data is presented to a user of the client device. The presentation of block 208 may comprise presenting the textual, image, or video data to the user through a display of the client device, producing audio through a speaker or headphones of the client device, and/or presenting the advertisement data in any other suitable manner. Exemplary user interfaces for a client device, by which the advertisements may be presented, are discussed below in conjunction with FIGS. 7A-7C, though it should be appreciated that embodiments of invention may present the advertisement data to a user in any suitable manner.

In block 210, the client device may detect an indication by a user that the user desires more information about the commercial service (e.g., product(s) and/or service(s)) of the advertisement presented in block 208. The indication may be, for example, the user clicking on a hyperlink included in the advertisement which directs the user to a web page containing additional information on the commercial service. The client device may then, in block 212, establish a network connection through the wireless access point transmitting the advertisement data and request over that network additional information regarding the commercial service (e.g., may request z web page linked to by the advertisement from a server on the network). In block 214, the wireless access point receives the additional information from, for example, a server associated with the wireless access point and transmits the additional information to the client device, which may then present the additional information to the user.

It should be appreciated that embodiments of the invention are not limited to implementing the illustrative process 200 of FIG. 2, or any particular process executing one or more acts of the process 200, as embodiments of the invention may implement any suitable techniques for exchanging information about products and/or services between a wireless access point associated with an entity and a client device. For example, embodiments of the invention may not provide additional information about a commercial service to a user of the client device and thus the process executed by such embodiments of the invention may not incorporate acts executed by blocks 210, 212, and 214 of process 200. As a further example, it should be appreciated that while FIG. 2 describes process 200 in terms of a commercial service being advertised by an entity, embodiments of the invention may be implemented by entities which are not commercial entities, and as such the product(s) and/or service(s) associated with the entity may not be commercial services.

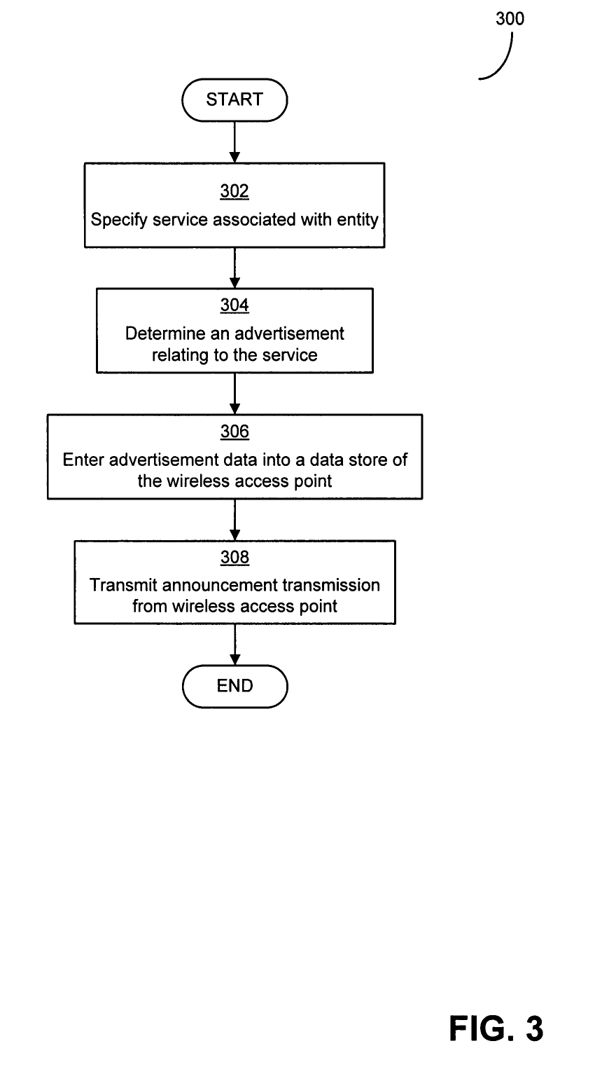

FIG. 3 shows an exemplary process 300 which may be implemented by entities such as entity 100 in accordance with one embodiment of the invention. It should be appreciated that embodiments of the invention are not limited to implementing any particular process to be executed or followed by entities, as embodiments of the invention may implement any suitable process to be executed or followed by entities.

Process 300 begins in block 302, wherein the entity specifies a service associated with the entity. As described above in conjunction with FIG. 2, in some embodiments of the invention the entity may be a commercial entity and the service specified in block 302 may be a commercial service (e.g., one or more products or services associated with the commercial entity) provided by the entity. Though, it is not necessary that the service be provided by the entity and any described type of service may be advertised. Specifying the service in block 302 may be done in any suitable manner, such as by a person associated with the entity (e.g., an administrator of the entity) determining a service he or she wishes to advertise, by software executing on an electronic device determining in any suitable manner a service which should be advertised, or in any other way.

Once a service has been specified in block 302, an advertisement for the service is determined in block 304. Determining an advertisement may comprise developing an advertisement for the specified service, or may comprise selecting an advertisement for the service from a preconfigured set of advertisements stored in a data store. The advertisement may comprise any suitable information, such as text, images, audio, or video, or any suitable combination thereof. Once an advertisement has been determined, then advertisement data describing the advertisement is encoded into a data store of a wireless access point. The advertisement data may be any suitable data in any suitable format describing the advertisement.

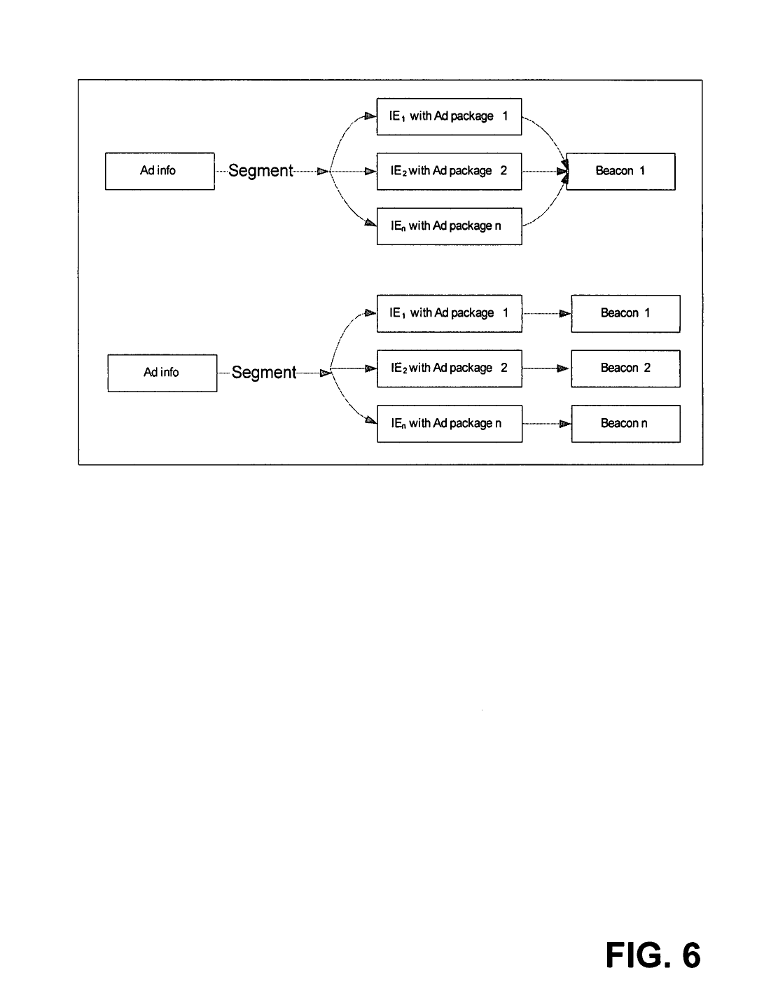

Once the advertisement data is encoded in the data store, it may be transmitted by the wireless access point to client devices within range of the wireless access point. The advertisement data may be transmitted as part of any suitable transmission, such as control transmission transmitted by the wireless access point. A control transmission may be an announcement transmission such as a beacon or probe response received by a client device prior to establishing a connection to the wireless access point. The transmission may be broadcast to all client devices within range of a wireless access point, or may be targeted toward one or more particular client devices. In embodiments in which announcement messages are repeatedly transmitted, advertisement data may also be transmitted repeatedly. Each announcement messages may contain the same repeated advertisement, though, in some embodiments of the invention, a wireless access point may transmit more than one advertisement and successive announcement messages may contain different advertisement data. The advertisement data encoded in the announcement transmission may be formatted in any suitable manner, such as the exemplary formats discussed below in conjunction with FIG. 6.

It should be appreciated that embodiments of the invention are not limited to implementing the exemplary process shown in FIG. 3, and that embodiments of the invention may implement any suitable process for transmitting advertisement data from a wireless access point associated with an entity. For example, while the process 300 is described as transmitting a single advertisement for a single service, in some embodiments of the invention the wireless access point may transmit multiple different advertisements for a single or multiple services. The multiple advertisements may be transmitted within a single announcement transmission or the wireless access point may switch between multiple advertisements such that the advertisement contained within announcement transmissions transmitted by the wireless access point may vary between announcement transmissions.

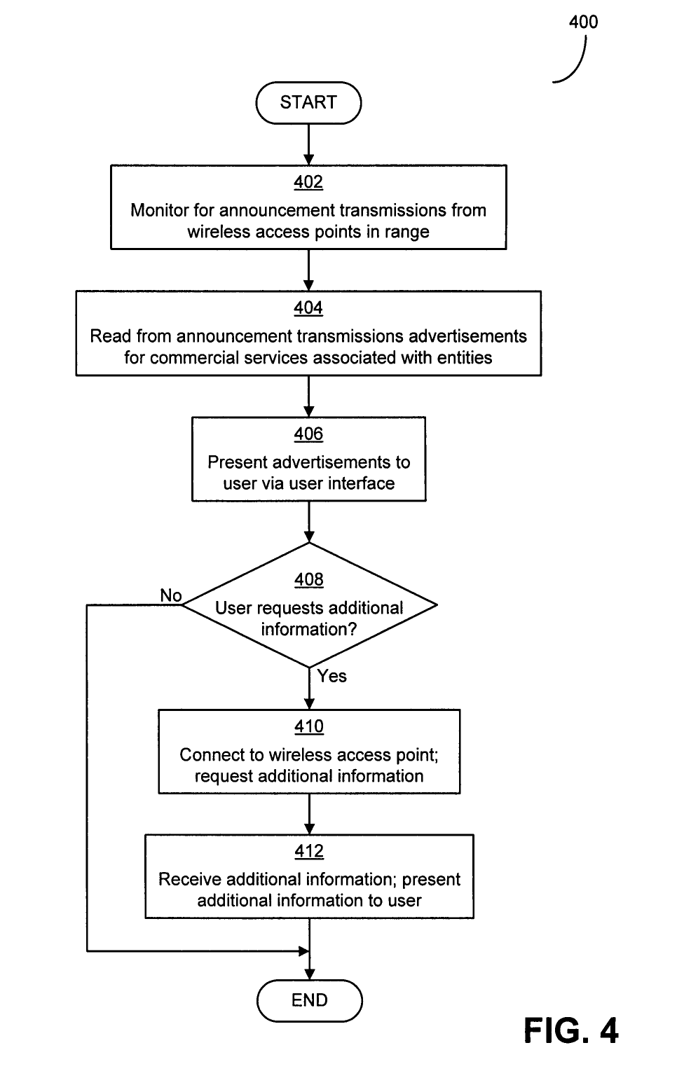

FIG. 4 shows an exemplary process 400 that may be executed or followed by a client device in accordance with some embodiments of the invention. It should be appreciated that process 400 is merely illustrative, and that embodiments of the invention may implement any suitable process for receiving advertising data from wireless access points, as embodiments of the invention are not limited in this respect.

The process 400 begins in block 402, wherein the client device monitors for announcement transmissions from wireless access points within range of the client device. Monitoring in block 402 may comprise receiving announcement transmissions from wireless access points and determining whether received announcement transmissions comprise advertisement data transmitted by the wireless access point. If the announcement transmissions do contain advertisement data, then the advertisement data may be read from the announcement transmission in block 404. The advertisement data may then be processed in any suitable manner and the advertisement(s) described by the advertisement data presented to the user via a user interface in block 406. As discussed above in conjunction with FIG. 2, the data may be presented may be done in any suitable manner, such as by presenting the textual, image, or video data to the user through a display of the client device or producing audio through a speaker or headphones of the client device. Exemplary user interfaces for a client device, by which the advertisements may be presented, are discussed below in conjunction with FIGS. 7A-7C, though it should be appreciated that embodiments of invention may present the advertisement data to a user in any suitable manner.

In block 408, the client device detects whether or not the user has requested more information about a service advertised in the advertisements presented in block 406. If not, the process 400 ends. If the user has indicated that he or she would like more information then, in block 410, a connection is established with the wireless access point transmitting the announcement transmission containing the advertisement data. Once a connection is established, the client device may request additional information on the service advertised in the advertisement. Requesting additional information may be done in any suitable manner, such as by requesting the additional information from the wireless access point or by requesting the additional information from a server on which the additional information is hosted (e.g., server 108 of FIG. 1). The client device may then receive the additional information in block 412 and present it to the user via the user interface or in any other suitable manner.

It should be appreciated that embodiments of the invention are not limited to implementing the exemplary process shown in FIG. 4 and that embodiments of the invention may implement any suitable process for receiving information, including advertisement data, about a service associated with an entity.

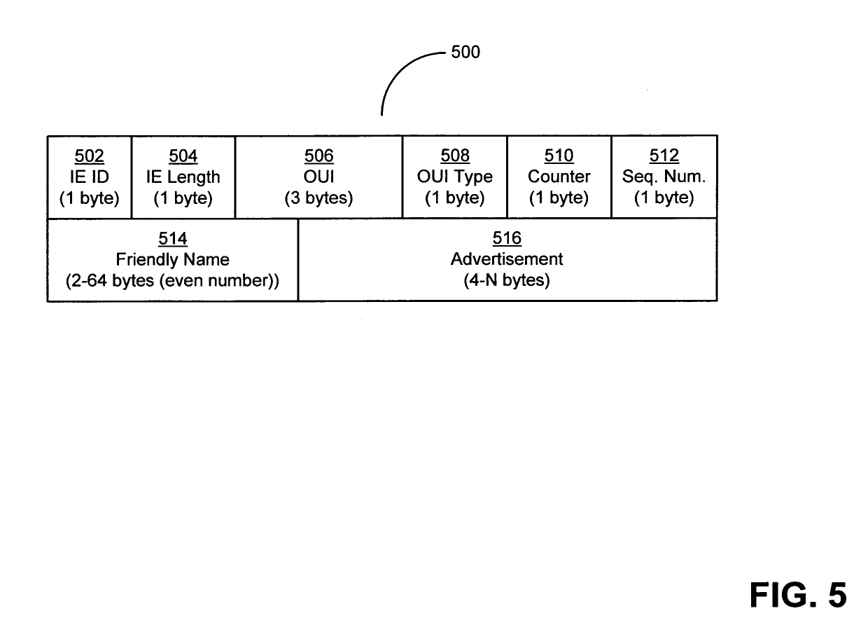

In embodiments of the invention transmitting advertisement data as a portion of an announcement transmission, the advertisement data may be transmitted in any suitable manner. FIG. 5 shows an exemplary techniques for transmitting advertisement data as part of an IEEE 802.11 beacon transmission. It should be appreciated that embodiments of the invention may operate according to any suitable protocol and are not limited to operating in accordance with the IEEE 802.11 protocol. Additionally, embodiments of the invention which are implemented to operate with the IEEE 802.11 protocol are not limited to implementing the exemplary techniques shown in FIG. 5 and may implement any suitable technique.

FIG. 5 shows one possible arrangement for advertisement data in a beacon transmission encoded within an IEEE 802.11 Information Element (IE) 500. According to the IEEE 802.11 standard, a beacon has an options field in which an “information element” may be inserted without deviating from the 802.11 protocol. In the embodiment illustrated, an advertisement is transmitted as an information element. In the example illustrated, IE 500 comprises an IE identifier (IE ID) 502, which is one byte indicating the particular type of IE, an IE length 504, which is one byte indicating the amount of data included in the IE 500, and an Organization Unique Identifier (OUI) 506, which is three bytes indicating a particular company which has defined the format of IE 500. In some embodiments of the invention, the IE ID 502 may have a value of 221 and the OUI may be assigned a value of “00-50-F2,” which indicates the IE 500 has a format defined by the Microsoft Corporation of Redmond, Wash. In accordance with the IEEE 802.11 standard, the IE 500 may further comprise a payload. In the example of FIG. 5, the payload of IE 500 comprises an OUI Type 508, further indicating the type of the IE 500, which may have a value of 7 indicating that it is an IE associated with advertisements.

In the example of FIG. 5, the payload of IE 500 further comprises a one-byte counter 510 and a one-byte sequence number 512, which may be used if the advertisement being transmitted cannot be transmitted within one IE 500 (due to, for example, size/space restrictions on the IE 500). The counter 510 may be used to indicate the number of information elements containing data describing the advertisement, and the sequence number 512 may be used to indicate the placement of the particular IE 500 in the order of IEs associated with the advertisement (e.g., whether the IE 500 is first out of three, second out of three, etc.).

Further, the payload of IE 500 comprising at least one of a combination of a friendly name 514 and an advertisement 516. The friendly name 514 may comprise a short description of the advertisement data contained in advertisement 516. For example, the friendly name 514 may be the name of a business transmitting the IE 500 (if the entity is a business) or may be a title or heading for the advertisement, such as “Today's Specials” if the advertisement in advertisement 516 is for a listing of the specials of the day for a restaurant. In some embodiments, friendly name 514 may be presented to a user by the client device to notify the user that an advertisement has been received. A user may then opt to view or ignore the advertisement.

As shown in FIG. 5, the friendly name 514 may comprise an even number of bytes from 2-64 bytes, and may be stored in wide char string type, which may or may not be terminated with a null terminator. Advertisement 516 may be formatted in any suitable format by the entity, and may be any number of bytes greater than four, as the first four bytes of the advertisement 516 are reserved as an identifier for the advertisement.

In the embodiment described above, each advertisement was transmitted in one announcement message. In such an embodiment, the advertisement may be limited to a size that fits within an announcement transmission according to the protocol under which the wireless access point operates. However, the invention is not limited to advertisements of this size. Multiple announcement transmissions may be used to communicate one advertisement. As shown in FIG. 6, in accordance with some embodiments of the invention advertisement data stored by a wireless access point 102 may be segmented into multiple information elements (IEs) (e.g., IE₁). Each IE may contain a portion of a single block of advertisement data which was too large to be encoded in a single IE. As indicated in FIG. 6, the data may be segmented into multiple information elements and broadcast in successive announcement messages or may be incorporated as separate IEs in one message. A client device receiving those announcements may recreate the advertisements using counter 510 and sequence number field 512 (see FIG. 5).

Conversely, advertisements may be small enough that multiple advertisements may fit within defined options fields for one announcement message. Each advertisement may be format as an information element, each IE containing advertisement data related to a different advertisement. These IEs may be any suitable structure for transmitting advertisement data, such as the exemplary IE formats discussed above in conjunction with FIG. 5. In some embodiments of the invention, the advertisement data, once segmented into multiple IEs, may then be combined into a single announcement transmission comprising multiple IEs (e.g., beacon 1). The collection of IEs may then be transmitted in the single announcement transmission from the wireless access point for receipt by client devices within range of the wireless access point.

It should be appreciated that while FIGS. 5-6 described transmitted advertisement data in terms of IEEE 802.11 beacon transmissions and information elements, embodiments of the invention are not limited to being implemented in IEEE 802.11 networks and are not limited to transmitting advertisement data in the information elements described by the IEEE 802.11 protocol or any other information element. Embodiments of the invention may operate on any suitable protocol and may transmit any suitable type or types of advertisement data in any suitable manner.

Once received by the client device, the advertisement data may be processed in any suitable manner (e.g., reading it from the structure in which it was transmitted, combining multiple IEs to construct a single advertisement, or any other suitable processing steps) and an advertisement described by the advertisement data may be presented to the user of the client device. The advertisement may be presented in any suitable manner by any suitable user interface. FIGS. 7A, 7B, and 7C show schematics of illustrative user interfaces employed on a client device 700 having a display screen 702. In embodiments of the invention, the client device 700 may additionally or alternatively comprise an audio output component, such as a speaker or headphones, by which audio signals described by the advertisement data may be generated. Additionally, in embodiments of the invention, the client device 700 may comprise input devices by which a user may provide any suitable input to the client device 700.

FIG. 7A shows a display screen 702 of a client device 700 having an area 704 of the screen 702 displaying advertisements described by the advertisement data received by the client device 700 from a wireless access point. In some embodiments of the invention, the area 704 of the screen 702 may display the advertisements sequentially, changing between advertisements displayed fully or, in alternative embodiments of the invention, the area 704 may display advertisements in a tickertape stream as shown in FIG. 7A (wherein an “Advertisement 1” is shown fully and an “Advertisement 2” is shown partially as it streams onto the screen) such that advertisements may be displayed in whole or in part as the advertisements stream. In some embodiments of the invention, the area 704 may not display the full advertisement described by the advertisement data, but may rather display a shortened or simplified form of the advertisement, such as the data contained in the friendly name 514 field of the IE 500 described above in conjunction with FIG. 5. Such a display may alert a user that an advertisement is available and allow the user to provide input to display the advertisement.

FIG. 7B shows an alternative embodiment of the invention, wherein a client device 700 with a screen 702 may display one or more advertisements 706 in full (three advertisements in the example of FIG. 7B). Unlike the area 704 of FIG. 7A, the user interface of FIG. 7B may take up a substantial portion of the screen 702.

In some embodiments of the invention, the advertisements 706 may be placed in the user interface such that the advertisements are not all displayed on the user interface at once, and the user may scroll through the advertisements in a vertical scroll, horizontal scroll, or any other suitable scroll.

In some embodiments of the invention, such as those displaying a shortened or simplified form of the advertisement in area 704 of FIG. 7A, the user interface may be adapted to detect an indication from a user of the client device that he or she would like more information regarding an advertisement shown in the area 704. Upon detecting such an indication, the client device 700 may change the content of display screen 702 from the content shown in FIG. 7A to, for example, the content shown in FIG. 7B, such that the full advertisement or a larger advertisement may be displayed to the user.

Further, in some embodiments of the invention the user interface may be adapted to detect a request for more information regarding the advertisement from a user and may, upon detecting the request, connect to the wireless access point transmitting the advertisement data and request additional information from the wireless access point or the client device may establish a connection to a network through the wireless access point and obtain additional information from a device connected to the network. Upon receiving the additional information, the client device may change the content of display screen 702 from the content previously displayed to the user (e.g., the content shown in FIG. 7A or FIG. 7B) to the content shown in FIG. 7C. As shown in FIG. 7C, the additional information requested from the wireless access point (which may be, for example, a web page) may be displayed on the display screen 702 as the sole content of the display screen 702 or as a significant portion of the display screen 702, or in any other suitable manner.

It should be appreciated that the illustrative user interfaces shown in FIGS. 7A-7C are merely exemplary of embodiments of the invention, and that embodiments of the invention are not limited to presenting advertisement data to a user of a client device via a display screen or any other particular user interface component, as embodiments of the invention are not limited in this regard.

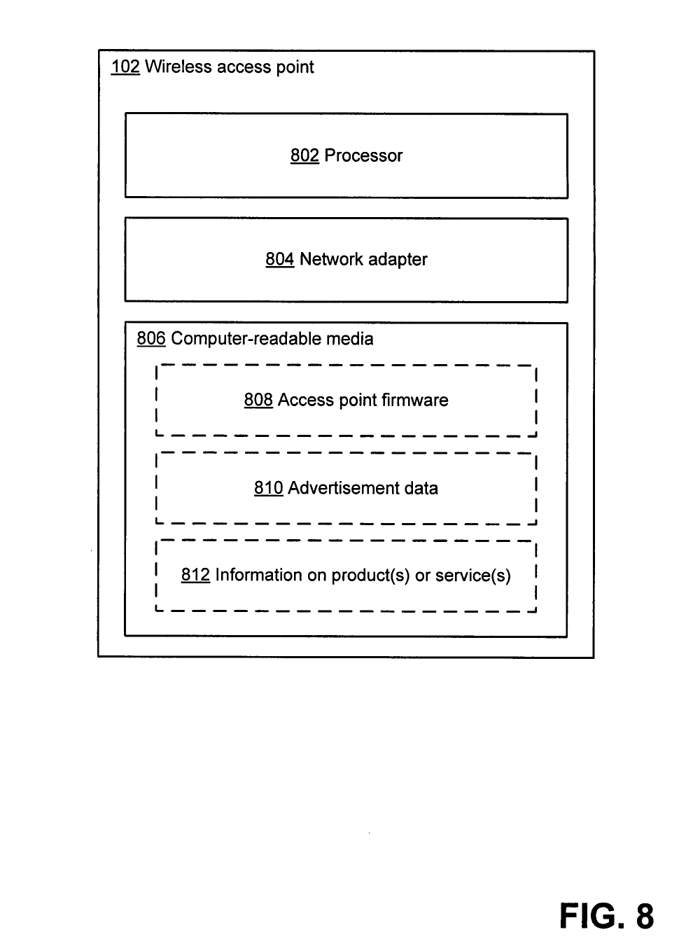

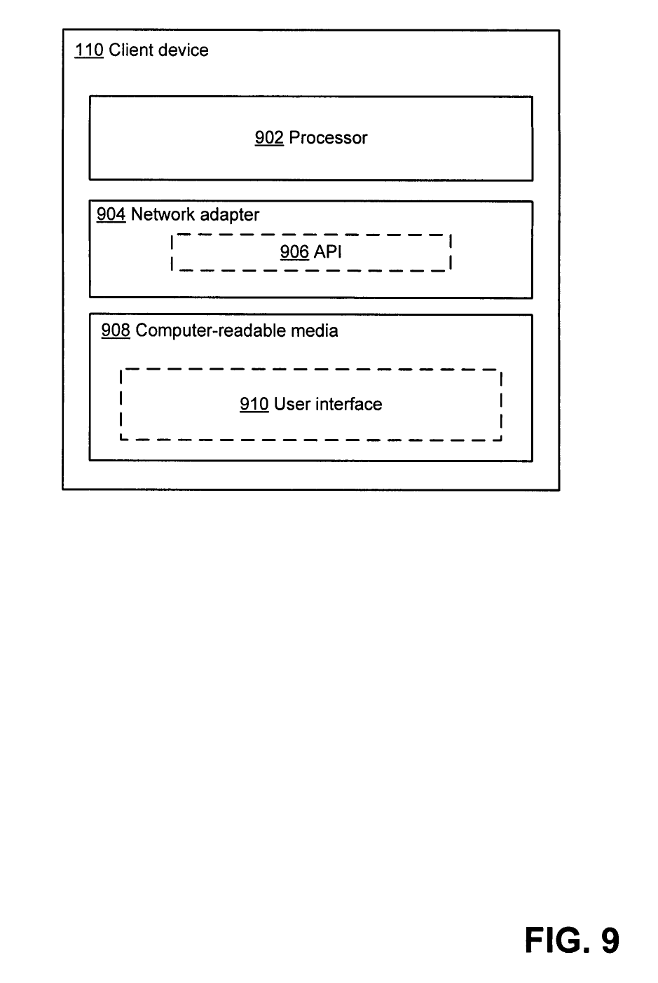

The aspects of the present invention described herein may be implemented on any of numerous computer system configurations and are not limited to any particular type of configuration. FIGS. 8-9 show various computer systems in which embodiments of the invention may act, though others are possible. It should be appreciated that FIGS. 8-9 are intended to be neither a depiction of necessary components for a computing device to operate as a wireless access point or client device with embodiments of the invention, nor a comprehensive depiction.

FIG. 8 shows an illustrative wireless access point 102 which may be implemented as a wireless access point in accordance with embodiments of the invention. Wireless access point 102 comprises a processor 802, a network adapter 804, and computer-readable media 806. Network adapter 804 may be any suitable hardware and/or software to enable the wireless access point 102 to communicate with any other suitable computing device over any suitable computing network. The computing network may be any suitable wired and/or wireless communication medium or media for exchanging data between two or more computers, including the Internet. For example, the computing network may be, at least in part, a wireless network operating according to any suitable wireless networking protocol, such as IEEE 802.11, GSM, Bluetooth, WiMAX, UWB, and/or any other suitable protocol. In some embodiments of the invention, wireless access point 102 may comprise two network adapters 804 to enable the wireless access point 102 to communicate with a wired computing network and a wireless computing network, and exchange data between the two. Computer-readable media 806 may be adapted to store data to be processed and/or instructions to be executed by processor 802. Processor 802 enables processing of data and execution of instructions. The data and instructions may be stored on the computer-readable media 806 and may, for example, enable communication between components of the wireless access point 102.

In accordance with some embodiments of the invention, data store 104 of FIG. 1 may be implemented as computer-readable media 806, and the data and instructions stored on computer-readable media 806 may comprise access point firmware 808, which may be software executed by the processor 802 instructing the wireless access point 102 to perform any suitable function, such as retrieving advertisement data from a data store for transmission, encoding the advertisement data in a control transmission, and generating a control transmission. The computer-readable media 806 may further store advertisement data 810 (i.e., advertisement data 106). Advertisement data 810 may be any suitable type or types of data that may be transmitted by a wireless access point 102, including, for example, data describing text, images, audio, or video, or any combination thereof. The advertisement data 810 may be data describing a single advertisement for one or more services associated with an entity associated with the wireless access point 102, or may be data describing multiple advertisements for one or more services associated with an entity. In embodiments of the invention, the entity may be a commercial entity (e.g., a business) and the services may be commercial services.

In some embodiments of the invention, the server 108 of FIG. 1 may additionally or alternatively be implemented as the computer-readable media 806 such that information 812 on the services of the advertisements described by the advertising data 810 may be stored on the computer-readable media 806. The information 812 may be additional information not contained in the advertisement data 810, and may be any suitable data in any suitable format, such as a web page comprising information regarding the services and/or information on buying or subscribing to the services.

FIG. 9 shows an exemplary client device 110 which may be implemented as a client device in accordance with embodiments of the invention. As discussed above, any suitable computing device, mobile or immobile, may be used as a client device 110 in accordance with embodiments of the invention. Client device 110 may be a computing device designed for multiple purposes and for use by a user, such as a desktop personal computer, a laptop personal computer, a server, a personal digital assistant (PDA), a smart/mobile telephone, or any other suitable electronic device. Alternatively, client device 110 may be any computing device not intended for typical use by a user or intended for a single purpose or limited purposes, such as a server or a rack-mounted networking device.

Client device 110 comprises a processor 902, a network adapter 904, and computer-readable media 908. Network adapter 904 may be any suitable hardware and/or software to enable the client device 110 to communicate with any other suitable computing device over any suitable computing network. The computing network may be any suitable wired and/or wireless communication medium or media for exchanging data between two or more computers, including the Internet. For example, the computing network may be, at least in part, a wireless network operating according to any suitable wireless networking protocol, such as IEEE 802.11, GSM, Bluetooth, WiMAX, UWB, and/or any other suitable protocol. Network adapter 904 may further comprise an Application Programmer Interface (API) 906 to enable interaction between the network adapter 904 and applications executing on the client device 110. API 906 may provide executable functions to applications on the client device 110 such that the applications may request that network adapter 904 begin monitoring for transmissions from wireless access points, provide advertising data from transmissions, request additional information from the wireless access points, or any other suitable function. Computer-readable media 906 may be adapted to store data to be processed and/or instructions to be executed by processor 902. Processor 902 enables processing of data and execution of instructions. The data and instructions may be stored on the computer-readable media 906 and, for example, may enable communication between components of the client device 110.

In accordance with some embodiments of the invention, the data and instructions stored on computer-readable media 908 may comprise a user interface 910 by which advertisement data and/or additional information regarding advertised product(s) or service(s) may be presented to a user. User interface 910 may present data in forms depicted in FIG. 7A, 7B, or 7C. User interface 910 may receive user input indicating that additional data is desired. In response to such an indication, user interface 9910 may initiate a network connection and access a URL specified in an advertisement or otherwise obtain additional information for presentation to a user. However, user interface 910 may be any suitable user interface presenting information to a user and accepting information from a user in any suitable format. In some embodiments of the invention, the user interface 910 may be a component of an operating system or firmware of the client device 110, while in alternative embodiments of the invention the user interface 910 may be a standalone application, or a piece of an application such that advertisements may be displayed within the application.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a client device may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a client device may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface including keyboards, and pointing devices, such as mice, touch pads, and digitizing tables. As another example, a computer may receive input information through speech recognition or in other audible format.

Such client devices may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or methods outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, etc.) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. In a wireless access point associated with a commercial entity in proximity to the wireless access point offering at least one commercial service, a method comprising:
encoding in the wireless access point an advertisement for the at least one commercial service; and
transmitting, from the wireless access point, at least one announcement transmission comprising the advertisement for the at least one commercial service.

2. The method of claim 1, wherein the at least one announcement transmission is at least one control message transmitted by a wireless access point comprising network characteristics enabling a client device receiving the at least one announcement transmission to open a connection to the wireless access point.

3. The method of claim 2, wherein the at least one control message is at least one beacon transmission periodically transmitted by the wireless access point, and the advertisement data is transmitted in the at least one beacon transmission as one or more information elements of the at least one beacon transmission.

4. The method of claim 1, further comprising an act of dividing the advertisement into a plurality of portions of the advertisement, and
wherein each announcement transmission of the at least one announcement transmission comprises a portion of the plurality of portions of the advertisement.

5. The method of claim 1, wherein the advertisement data comprises at least one of text data, image data, audio data, and/or video data.

6. The method of claim 1, further comprising acts of:
establishing a connection to at least one client device; and
transmitting information regarding the at least one commercial service to the at least one client device.

7. A client device operating in a network environment comprising a plurality of wireless access points, at least a portion of the wireless access points being within range of the client device, the client device comprising:
a wireless network interface adapted to receive at least one announcement transmission from each wireless access point in the portion;
a processor adapted to receive from the wireless network interface advertisement data from each announcement transmission of the at least one announcement transmission from each wireless access point in the portion, the advertising data describing a commercial service offered by a commercial entity associated with a wireless access point in the portion; and
a user interface adapted to present the advertisement data to a user of the client device.

8. The client device of claim 7, wherein the at least one announcement transmission is at least one control message transmitted by a wireless access point comprising network characteristics enabling a client device receiving the at least one announcement transmission to open a connection to the wireless access point.

9. The client device of claim 7, wherein the at least one announcement transmission is at least one beacon periodically transmitted by each wireless access point in the portion.

10. The client device of claim 9, wherein the advertisement data is transmitted in the at least one beacon transmission as one or more information elements of the at least one beacon transmission.

11. The client device of claim 7, wherein each wireless access point in the portion is associated with a commercial entity, and wherein the advertisement data contained in the at least one announcement transmission describes an advertisement for at least one commercial service provided by the commercial entity.

12. The client device of claim 7, wherein the at least one announcement transmission received in the act of receiving is received from at least one wireless access point to which the client device is not connected.

13. The client device of claim 7, wherein the user interface is further adapted to detect an indication from a user that the user desires more information on the commercial service described by the advertisement data, and the network adapter is further adapted to establish a connection to at least one wireless access point in the portion and request information on the commercial service.

14. A method of operating a client device in a network environment comprising a plurality of wireless access points, at least a portion of the wireless access points being within range of the client device, the method comprising:
receiving at least one control message from each wireless access point in the portion;
reading advertisement data from each control message of the at least one control message from each wireless access point in the portion, the advertising data describing at least one commercial service offered by a commercial entity associated with a wireless access point in the portion; and
presenting via a user interface advertisements described by the advertisement data.

15. The method of claim 14, wherein the at least one control message is at least one announcement transmission transmitted by a wireless access point comprising network characteristics enabling a client device receiving the at least one announcement transmission to open a connection to the wireless access point.

16. The method of claim 15, wherein the at least one announcement transmission is at least one beacon transmission periodically transmitted by the wireless access point.

17. The method of claim 16, wherein the advertisement data is transmitted in the at least one beacon transmission as one or more information elements of the at least one beacon transmission.

18. The method of claim 14, wherein at least one control message is received from a wireless access point to which the client device does not have an open connection.

19. The method of claim 14, further comprising acts of:
detecting an indication from a user that the user desires more information on at least one commercial service described by the advertisement data;
establishing a connection to at least one wireless access point in the portion; and
receiving from the at least one wireless access point to which a connection is established information regarding the at least one commercial service.

20. The method of claim 14, further comprising an act of joining together into a single object the advertisement data contained in a plurality of control messages prior to presenting an advertisement to a user via a user interface.
